(19) United States
(12) Patent Application Publication
(10) Pub. No.: US 2017/0004450 A1
(43) Pub. Date: Jan. 5, 2017

(54) RECRUITING FOR A JOB POSITION USING SOCIAL NETWORK INFORMATION

(71) Applicant: Linkedln Corporation, Mountain View, CA (US)

(72) Inventors: Mehul Kamlesh Rathod, Fremont, CA (US); Utkarsh Kishor Contractor, Fremont, CA (US); Wilmar DeJesus Bolivar, Sunnyvale, CA (US)

(21) Appl. No.: 14/755,651

(22) Filed: Jun. 30, 2015

(51) Int. Cl. G06Q 10/10

(52) U.S. Cl. CPC G06Q 10/1053

(57) ABSTRACT

In various example embodiments, a system and method for recruiting candidates are presented. A job posting specifying a plurality of criteria for a job position from a user of a social network service may be received. The job posting being associated with a company comprising of at least one employee is determined. At least one candidate within the at least one employee's professional network is identified to possess a plurality of credentials that match the criteria of the job posting. A recommendation prompt can be presented to the at least one employee providing a suggestion to the employee to recommend the job position to the candidate within the employee's network.

### TECHNICAL FIELD

Embodiments of the present disclosure relate generally to online social networking, and more particularly, but not by way of limitation, to recruiting for a job position using social network information.

### BACKGROUND

Recruiting potential employees that are well qualified for a particular position with the correct attitude to fit with a company's culture is time consuming and resource intensive for both the corporation and a potential candidate. Proposing a job position to a well-qualified candidate through a channel in which the candidate trusts may facilitate the recruiting process and therefore save time and resources for both parties involved in the recruiting process. Conventionally, job seekers often may not hear back after applying for a job and therefore leads to a poor candidate experience with the company's hiring process. On the other side of the hiring process, recruiters often attempt to recruit a potential candidate directly and are often ignored by the potential candidate due to a lack of trust.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed, according to some example embodiments.

FIG. 2 is a block diagram depicting an example embodiment of a recruiting system, according to some example embodiments.

FIG. 3 is a block diagram illustrating an example of information flow for determining eligible candidates to recruit for a job posting, according to some example embodiments.

FIG. 4 is a flow diagram illustrating operations to determine employees to send a recommendation prompt to facilitate recruiting of an eligible candidate, according to some example embodiments.

FIG. 5 is a flow diagram illustrating further operations for notifying users of a job recommendation for facilitating the recruiting process, according to example embodiments.

FIG. 6A is a flow diagram illustrating an example method for determining a successful recruitment based on status updates, according to example embodiments.

FIG. 6B is a flow diagram illustrating an example method for determining a successful recruitment based on received notifications, according to example embodiments.

FIG. 7 depicts an example user interface for interactively presenting career navigation to the user, according to example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The features of the present disclosure provide a technical solution to the technical problem of generating a network channel to target a qualified potential candidate for a specific job position in order to maximize the likelihood of interest and response by the potential candidate. The network recruiting system provides, in some embodiments, the technical benefit of identifying candidates that are well qualified for the specific position at a company and generating a prompt to an employee of the company, inviting the employee to recommend the job position to the potential candidate. Conventionally, when a recruiter directly contacts the potential candidate, the potential candidate does not know the recruiter and would likely ignore any attempts from the recruiter to attract the candidate. Accordingly, a network recruiting system can be used to identify an existing channel of trust or create a channel of trust using a mutual network between the company and the candidate to give the recruiter a higher likelihood of credibility from the perspective of the candidate. A channel of trust can be in the form of a network connection that is shared between the company and the candidate (e.g., the company has an employer, and the employer is directly connected to the candidate). This reduces time and resources spent on the recruiting process. As a result, the network recruiting system provides the benefit of automatically identifying the potential candidates that are well qualified for a job position and determining the best network channel to approach the candidate and recommend the job position to increase the likelihood of the candidate responding.

In various example embodiments, systems and methods for recruiting for a job position using online social network information are described. Online social network information can include online professional network information. A professional network is a type of online social network that focuses on interactions and relationships involving a professional and business nature rather than nonbusiness interactions. A recruiting system, part of a social networking system 120, can be used by a recruiter when seeking specific individuals possessing specific skill sets and talents for the purpose of employment. Generally, during a recruiting process, a job is advertised through a job posting detailing attributes that are required along with other attributes that are desired for a successful candidate for the specific job position. The job posting could be posted by a recruiter or a person working for a corporation on websites that have a reputation of attracting job seekers such as LinkedIn® (an online professional network services possessing significant directory of professionals seeking to maintain, build, and expand their network).

In some example embodiments, in response to receiving the job posting, a recruiting system can be used to identify an existing channel of trust or create a channel of trust using a mutual network between the company and the candidate. The recruiting system identifies the channel of trust by first extracting the criteria from the job posting including required skills, desired skills, corporation, location, salary, corporation perks, recruitment reimbursement amount, and other types of information usually associated with a job posting. From the extracted criteria, the recruiting system identifies the company associated with the job posting. The recruiting system then accesses a database and identifies employees within the company's network who are connected to candidates that match the criteria listed in the job posting, the candidates not already being employees. The recruiting system then sends a recommendation prompt to the employee (the employee that is connected to the candidate's professional network), inviting the employee to recommend the job position to the identified candidate within the employee's network. The employee will be presented this recommendation prompt when the employee signs in to their member profile. Determining a network channel to reach the potential candidate through a person the candidate knows generally increases the trust factor that a candidate has towards the attempt to recruit the candidate and therefore increase the likelihood of the candidate responding.

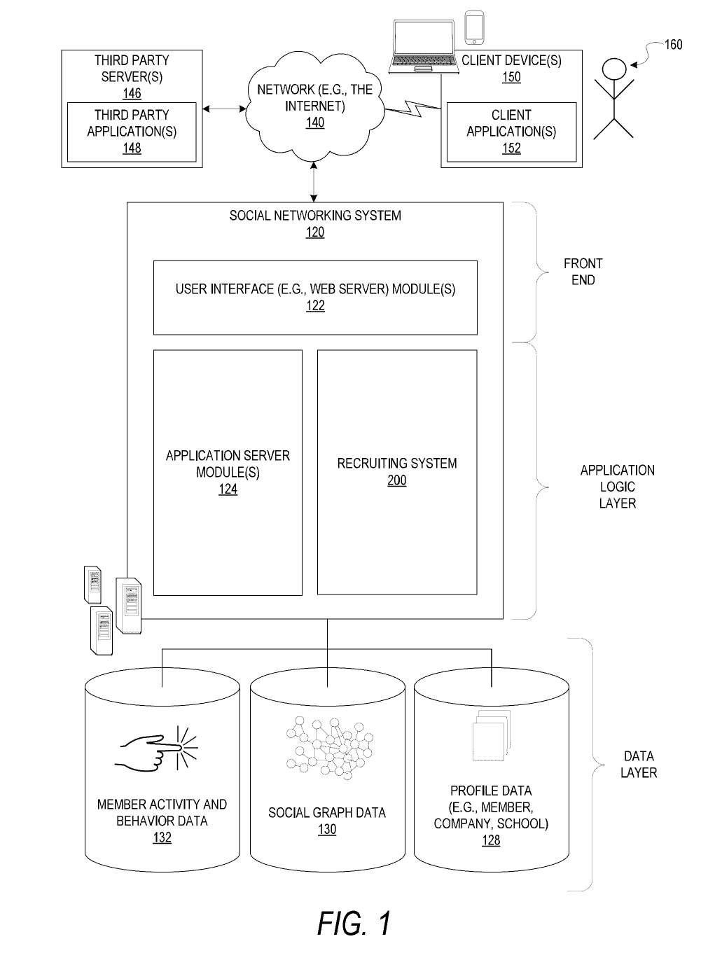

As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone). For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include a recruiting system 200, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

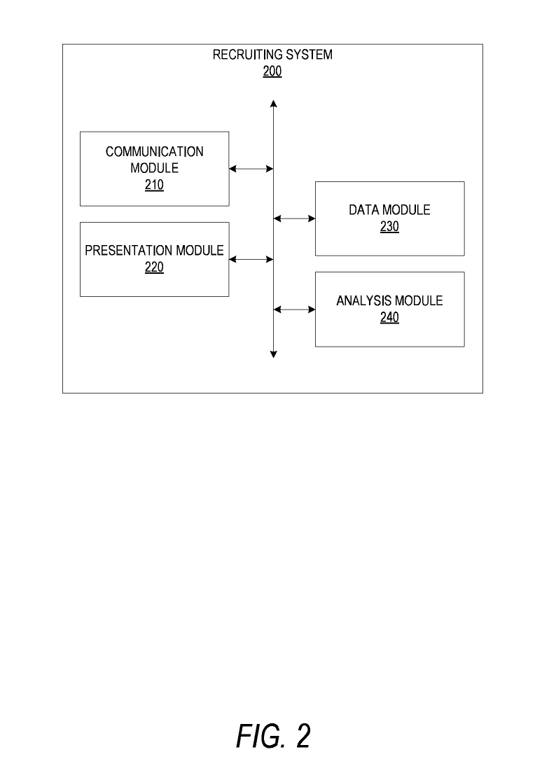

FIG. 2 is a block diagram illustrating components provided within the recruiting system 200, according to some example embodiments. The recruiting system 200 includes a communication module 210, a presentation module 220, a data module 230, and an analysis module 240. All, or some, of the modules are configured to communicate with each other, for example, via a network coupling, shared memory, a bus, a switch, and the like. It will be appreciated that each module may be implemented as a single module, combined into other modules, or further subdivided into multiple modules. Any one or more of the modules described herein may be implemented using hardware (e.g., a processor of a machine) or a combination of hardware and software. Other modules not pertinent to example embodiments may also be included, but are not shown.

The communication module 210 is configured to perform various communication functions to facilitate the functionality described herein. For example, the communication module 210 may communicate with the social networking system 120 via the network 140 using a wired or wireless connection. The communication module 210 may also provide various web services functions such as retrieving information from the third party servers 146 and the social networking system 120. In this way, the communication module 220 facilitates the communication between the recruiting system 200 with the client devices 150 and the third party servers 146 via the network 140. Information retrieved by the communication module 210 may include profile data corresponding to the user 160 and other members of the social network service from the social networking system 120.

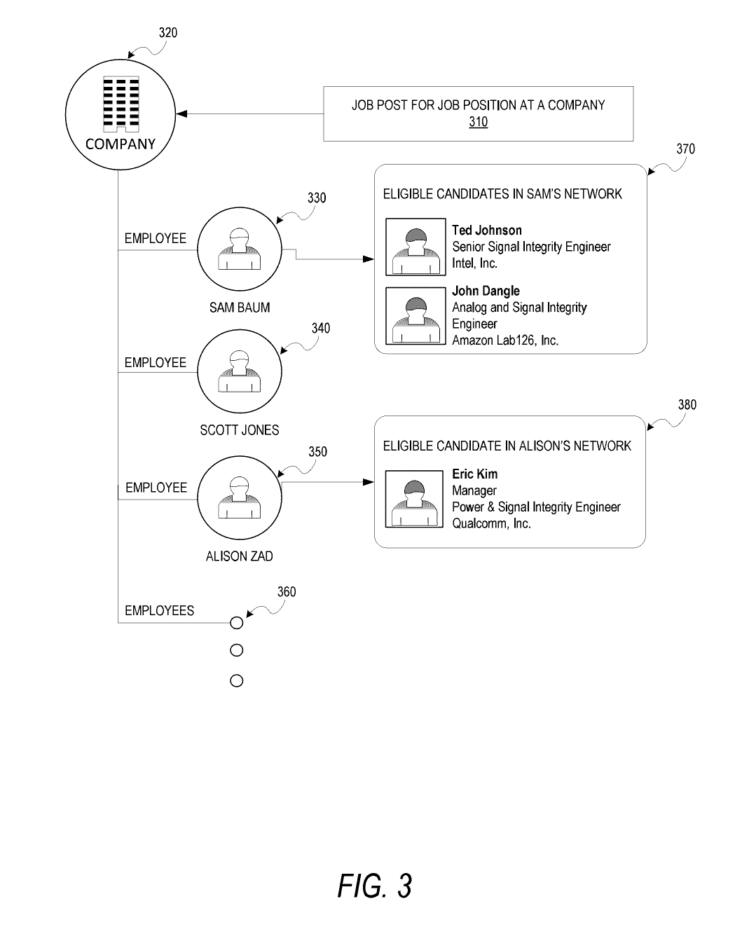

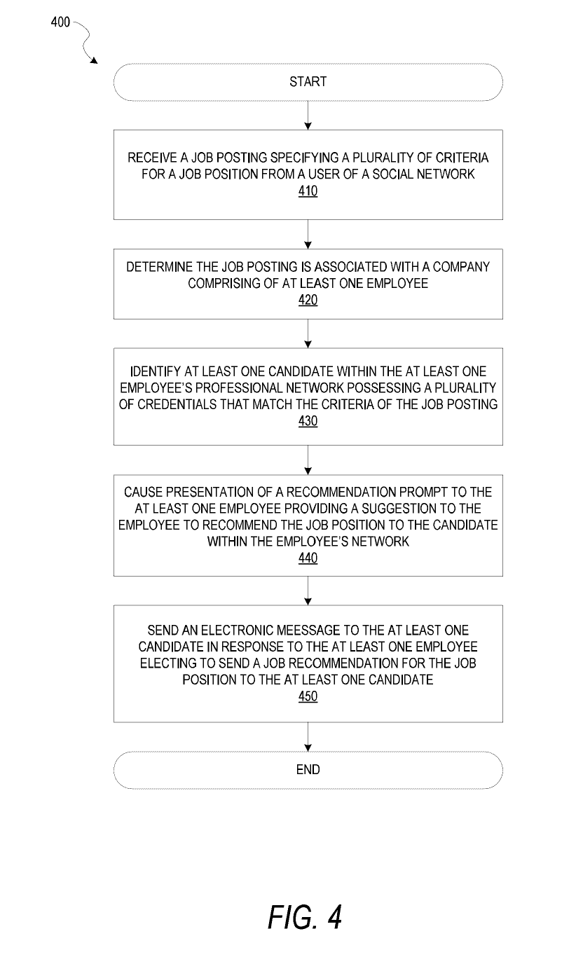

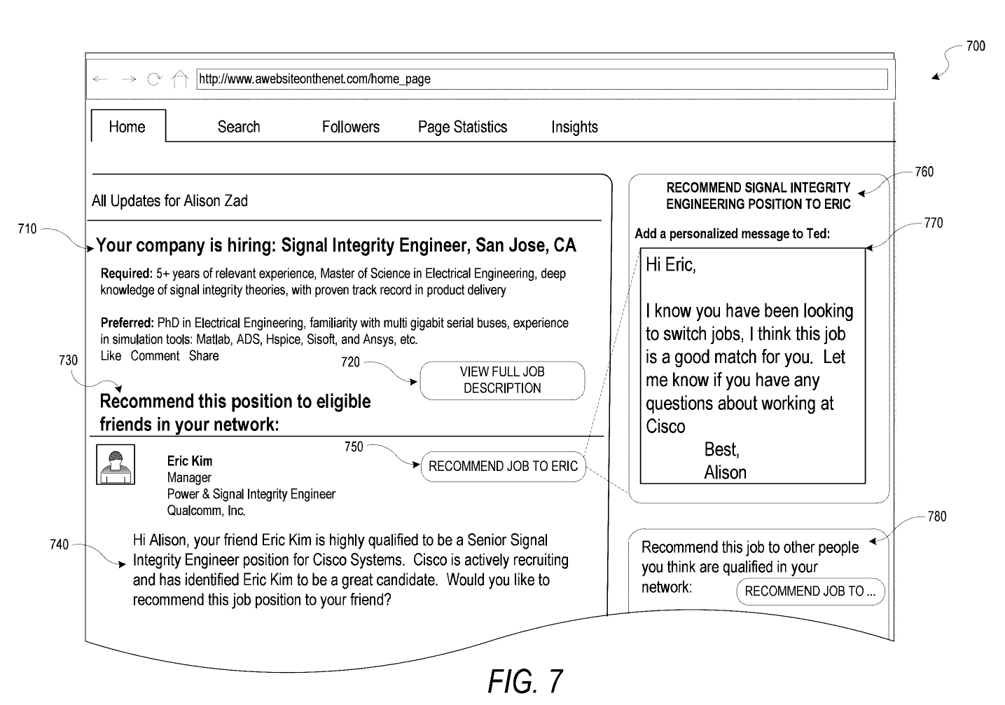

In some implementations, the presentation module 220 is configured to send electronic messages that include recommendation prompts to certain employees. For instance, the recommendation prompt provides suggestions to the employee to recommend the job to specific eligible candidates within the employee's network as depicted in FIG. 7. In various implementations, the recommendation module 220 also sends automatically generated recommendations to eligible candidates in response to the employee electing to recommend the job. Further details associated with the presentation module 220, according to various example embodiments, are discussed below with respect to FIG. 3 and FIG. 4. In various implementations, the presentation module 220 presents or causes presentation of information (e.g., visually displaying information on a screen, acoustic output, haptic feedback). Interactively presenting information is intended to include the exchange of information between a particular device and the user of that device. The user of the device may provide input to interact with a user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 220 provides many other user interfaces to facilitate functionality described herein. Further, it will be appreciated that “presenting” as used herein is intended to include communicating information or instructions to a particular device that is operable to perform presentation based on the communicated information or instructions via the communication module 210, data module 230, and analysis module 240. The data module 230 is configured to provide various data functionality such as exchanging information with databases or servers. For example, data module 230 may extract criteria from a job posting being posted by a recruiter looking for a successful candidate for a job position at a company. Further, the data module 230 may access member profiles that include profile data from the database 128 to identify employees within the company's network and further identify people who are within the employee's network for the analysis module 240 to execute credential matching. The data module 230 may also extract attributes and/or characteristics from the profile data of member profiles. Similarly, the data module 230 may access social graph data and member activity and behavior data may be accessed from respective databases 130 and 132. In some example embodiments, the data module 230 may exchange information with third party servers 146, client devices 150, and other sources of information.

The analysis module 240 is configured to execute a credential match by identifying candidates within the database that possess the extracted criteria of the job posting. Further, the analysis module 240 then calculates a score for each identified candidate. For each candidate possessing the required criteria, a point is assigned to the candidate for each criteria of job posting 310 that the candidate matches. The job posting 310 lists criteria for a successful candidate, where the criteria of the job posting can include listings of required criteria (credentials that are required of the candidate), and preferred criteria (credentials that are additionally preferred for the candidate to possess). Further, only the candidates with scores above a certain predefined threshold may be considered for active recruiting. In some implementations, employees that recruit candidate may be paid a recruitment reimbursement. For instance, the analysis module 240 determines when to distribute recruitment reimbursement amounts after an employee successfully recruits a candidate. Further details associated with the analysis module 240, according to various example embodiments, are discussed below with respect to FIG. 3 and FIG. 4.

FIG. 3 is a block diagram illustrating an example of information flow for the recruiting system 200. In some implementations, the analysis module 240 receives a job posting 310 recruiting for a job position from a user of a social network service. In an example, the user can be a recruiter or head hunter recruiting for a specific company and looking for a candidate with the right credentials to fill the job position. The job posting 310 can include information such as a job title, required skill sets, desirable skill sets, required level of education, desired years of experience in the field, the company name, the location of the job, etc. In an example, a recruiter can be recruiting for Cisco Systems, list a job posting 310 seeking for a Senior Signal Integrity Engineer for the company's San Jose office with the required qualifications of five or more years of experience in signal integrity and a Master of Science in Electrical Engineering, with preference for a candidate who holds a PhD in Electrical Engineering. Further, the job posting 310 includes required qualifications of having a deep knowledge of signal integrity theories, with proven track record in product delivery. The job posting 310 can also include desirable or preferred qualifications, including familiarity with multi gigabit serial buses, experience in simulation tools such as Matlab, ADS, Hspice, Sisoft, and Ansys, and an understanding of Electromagnetics and High Speed Signaling.

In further example embodiments, the recruiter can also specify a recruitment reimbursement amount associated with the job posting 310. The recruitment reimbursement amount may be an amount that an employee is compensated in exchange for a successful referral. For instance, the recruitment reimbursement is the amount of compensation (usually in terms of dollar amount) that an employee of a company would receive if the employee successfully refers a candidate for a job at the company and the candidate goes through the interview process and accepts the job. Further, the job posting 310 can include the criteria that the employee will receive the reimbursement amount after a specific duration of time has passed after the candidate has accepted the position, where the specific duration of time varies depending on the job position. For instance, John is an employee at LinkedIn and refers a friend to a software engineering position at LinkedIn. If the friend interviews with LinkedIn, is offered the software engineering position, and the friends accepts the position, John would receive a specific amount of money for the successful referral after ninety days of the friend's acceptance of the job offer. The reimbursement amount varies based on the type of job and level of expertise required by the job. Typically, the high the skill, experience, and education required for a job position, the higher the reimbursement amount would be for the employee. In an example, a junior software engineer would have a reimbursement amount of $2,000 USD, where a senior software engineer would have a reimbursement amount of $3,000 USD, and a senior manager for an engineering department would have a reimbursement amount of $5,000 USD. In other example embodiments, the reimbursement amount to the employee would depend on the quality of performance of the candidate during a specific duration of time.

Referring back to FIG. 3, the data module 230 extracts all the criteria for a successful candidate as described in the job posting 310. From the extracted criteria, the data module 230 determines that the job posting is associated with a company 320 and the company comprises of at least one employee that is within a potential candidate's professional network. In some example embodiments, the data module 230 accesses a database to identify employees 330, 340, 350, and 360 within the company's network. For instance, referring to the job posting 310 for a signal integrity engineer example above, the data module 230 determines that the job is at the company Cisco Systems. The data module 230 then access a database to identify people within the employees' network. From the identified employees' network, the analysis module 240 identifies potential candidate within the employee's professional network that match the criteria described in the job posting 310. In some implementations, the match is an exact match between the criteria listed in the job posting 310 and the credentials possessed by the employee. In other implementations, the match is a fuzzy match between the criteria listed in the job posting 310 and the credentials possessed by the employee. For each credential that is deemed to be a match (in both an exact match and a fuzzy match), predetermined points are assigned, as fully described in detail below.

In various example embodiments, the analysis module 240 is configured to determines at least one candidate within the at least one employee's professional network possessing a plurality of credentials that match the criteria of the job posting. The analysis module 240 identifies the at least one candidate by identifying a credential match between people within the professional network of an employee and the credentials described in the job posting 310. The credentials described can include credentials that are required for the candidate to possess, and credentials that are additionally preferred for the candidate to possess. The analysis module 240 executes a credential match by identifying candidates within the database that possess the extracted criteria of the job posting 310. The analysis module 240 then calculates a score for each identified candidate.

In further example embodiments, the analysis module 240 matches a candidate's credentials with the required credentials as described in the job posting. The analysis module 240 matches based on multiple dimensions depending on the attributes that are required in order for a candidate to be considered for the job and the attributes that are only preferred as described in the job posting. The required attributes can include education level, years of experience, or the like. The analysis module 240 first identifies key word matches between the required attributes in the job posing 310 and potential candidates by comparing the key words of the required attributes with key words in the candidate's profiles, where the profile include information regarding to skill set, current position, past position, and education. For example, referring back to FIG. 3, to the job listing 310 seeking a Senior Signal Integrity Engineer above, the analysis module 240 would match the required fields of Master of Science in Electrical Engineering, “signal integrity theories,” and “product delivery.” The analysis module 240 will further match the description fields in the candidate's profiles with the non-required criteria, including the desirable or preferred qualifications in the job posting 310. For example, the analysis module 240 identifies match in keywords such as “simulation tools,” electromagnetic,” and “speed signaling.”

In other embodiments, the matching performed by the analysis module 240 is not an exact match, but rather a fuzzy match. A fuzzy match is where there is predetermined equivalence between the two concepts that would be considered acceptable and thereby considered a match Fuzzy matching describes a technique for approximate matching between sequences of characters (string). The technique identifies a positive match where a first string matches a second string approximately rather than an exact match. For example, the candidate having a Master Degree in Computer Engineering would be considered qualified for this position because Computer Engineering can be considered equivalent to Electrical Engineering. The analysis module 240 would consider the candidate to be a potential candidate to recruit. In some embodiments, an exact match is weighted more heavily than a fuzzy match. In various other embodiments, an exact match is weighted the same as a fuzzy match.

In yet further example embodiments, the analysis module 240 then calculates a score for each identified candidate that meet the required criteria by the job posting 310. For each candidate possessing the required criteria, a predetermined point value is assigned to the candidate for each credentials in the candidate's profile that matches the criteria listed in the job posting 310. The predetermined point values may be the same for different types of credentials (e.g., each job title match may be 1 point, and each education level may be 1 point), or may be different (e.g., each job title match may be 2 points, and each education level may be 1 point, and the like). Further, only the candidates with scores above a certain predefined threshold may be considered for active recruiting. In some implementations, the threshold may be a point based system, where candidates above a certain threshold point will be considered for active recruiting. In other implementations, the threshold can be based on the candidate having to match all the credentials of the require criteria (credentials that are listed in the job posting as required of the candidate). Accordingly, the recruiter may set the predefined threshold to recruit candidates with a specific score, the score reflecting the match of the candidate's credentials with the preferred qualifications of the job posting.

In yet further example embodiments, the score calculated by the analysis module 240 is further based on the likelihood the candidate would be switching jobs in the near future. The analysis module 240 assigns one or more extra points to the candidate that is determined to have a high likelihood of switching jobs in the near future. The analysis module 240 determines that a candidate would likely be changing jobs by analyzing the candidate's job history and determining the average length of time that the candidate holds a job position. Analysis of the candidate's job history is highly suggestive of the candidate's intentions, particularly as it relates to his or her current employment intentions. Where the analysis module 240 determines that the time since the candidate begin his or her current job approaches the average length of time that the candidate holds a job position, the candidate is identified to have a high likelihood of switching jobs in the near future. Where the candidate is identified to have a high likelihood of switching jobs in the near future, the analysis module 240 assigns an extra point to their score. In an example, a candidate's job history shows that he has switched between four different engineering positions between four different companies in the last nine years. Therefore, the analysis module 240 determines that candidate usually leaves a job in approximately 2.25 years and is at his current job position for 2.1 years. Since the analysis module 240 determines that the average length of time for this particular candidate is ending soon, the candidate has a high likelihood of switching jobs based on the job history, and therefore assigns a point to the candidate's score. The trend in his employment history highly suggests that the candidate may seek to switch job positions after approximately two years at his current position. Accordingly, targeting a candidate with a high likelihood of switching jobs can lead to a greater chance of success in recruiting that candidate. As a result, the matching process results in identifying the best eligible candidates for the recruiter to choose from and subsequently interview for the job position. The best eligible candidates may range from candidates that meet at least the minimum of the required criteria of the recruiting criteria to candidates that possess all the required criteria and all the preferred criteria as specified by the job posting.

Referring to an example in FIG. 3, the credential match between people within the professional network of employee 330 and the credentials described in the job posting 310 results in eligible candidates 370. The credential match between candidates within the professional network of employee 350 and the credentials described in the job posting 310 results in eligible candidate 380. The employee is a person employed by the company that has been determined by the analysis module 240 to be associated with the job position of the posting. The candidates within the professional network of the employee can be a first connection, that is, people that are directly connected to the employee in the professional network. Also, the candidates within the professional network of the employee can be a second connection, that is, people that are connected to a person in the first connection of the employee. Further, the professional network connection can extend to a third connection, fourth connection, and so forth. The closer the degree of connection, the more heavily the candidate would be weighted to prompt the employee to send a job recommendation. The closer the degree of connection, the more likely a candidate would trust the recommendation for the job position from the employee, and thus the candidate would more willingly entertain the prospect of interviewing and accepting the job position. Accordingly, a first connection network is preferred because there is a higher chance the candidate would likely consider a job recommendation from a person that is a direct connection, rather than a connection of a connection.

FIG. 4 is a flow diagram illustrating an example method 400 for determining eligible candidates in recruiting for a job position using social network information, according to example embodiments. The operations of the method 400 may be performed by components of the recruiting system 200. At operation 410, the user interface receives a job posting specifying a plurality of criteria for a job position from a user of a social network service. The user in example form of a recruiter who posted the job posting 310, a head hunter looking for a candidate, or any person using the system to seek an eligible candidate for a position. According to various example embodiments, the data module 230 extracts all the criteria for a successful candidate as described in the job posting. The job posting may include required criteria for the position as well as preferred qualifications. The data module 230 may communicate the extracted criteria to the user analysis module 240 for further identification of qualified candidates.

At operation 420, the data module 230 determines that the job posting is associated with a company comprising of at least one employee. From the extracted information of the job posting, the data module 230 identifies that the job position is at a specific company. In response, the data module 230 accesses the database to identify the employees within the company's network along with people within those employees' network.

At operation 430, the analysis module 240 identifies at least one candidate within the at least one employee's professional network possessing a plurality of credentials that match the critera of the job posting. The criteria of the job posting can include listings of required criteria (credentials that are required of the candidate), and preferred criteria (credentials that are additionally preferred for the candidate to possess). The analysis module 240 identifies which candidates within the company's employees' professional network possess credentials that match at least the required criteria. The analysis module 240 then calculates a score for each identified candidate. Further detail of the matching process have been described in association with FIG. 3 above.

At operation 440, the presentation module 220 cause presentation of a recommendation prompt to the at least one employee inviting the employee to recommend the job position to the candidate within the employee's network. The employee was determined to be an employee or member of the company that is associated with the job position and the candidate is within the professional network of the employee. The recommendation prompt is presented in example form of the employee's home page or an automated electronic message.

According to various example embodiments, when the employee logs in to their profile, the presentation module 220 surfaces a recommendation prompt for the employee to recommend to one of the eligible candidates within the employee's network as depicted in FIG. 7. The recommendation prompt provides a suggestion to the employee to recommend the job position to the candidate within their network. For example, referring back to FIG. 3, the suggestion sent to employee 350 to provide a suggestion to recommend the job position to the eligible candidate 380 may state, “Hi Alison, your friend Eric Kim is highly qualified to be a Senior Signal Integrity Engineer position for Cisco Systems. Cisco is actively recruiting and has identified Eric Kim to be a great candidate. Would you like to recommend this job position to your friend?” The suggestion may be provided to the employee 350, for example, by the presentation module 220.

According to various example embodiments, the employee can elect to send an automatically generated recommendation to the candidate within their network via an electronic message. An electronic message can include email, text messaging, updates that surfaces in the candidate's profile page, and other similar means of sending the message to the candidate. The employee also has the option to edit the automated electronic message and add a personalized message in addition to the automatically generated message. For example, employee 350 may elect to add in a personalized message stating, “Hi Eric, I know you have been looking to switch jobs, I think this job is a good match for you. Let me know if you have any questions about working at Cisco!”

At operation 450, the recommendation module 220 sends an electronic message to the at least one candidate in response to the at least one employee electing to send a job recommendation for the job position to the at least one candidate. Referring back to the example in FIG. 3, in response to an employee electing to send a recommendation prompt to the eligible candidate 380 to provide the suggestion, the recommendation module 220 automatically sends an electronic message to the eligible candidate 380. The email send to the eligible candidate 380 may state, “Dear Eric, your friend Alison Zad is recommending the open job position of Senior Signal Integrity Engineer at Cisco Systems. Alison has said [insert personalized message from employee 350].” The automated electronic message sent to the eligible candidate further includes information about the job obtained from job posting and the employee who recommended to the job to the candidate. Optionally, the message also includes incentives added by the recruiter who posted the job posting for the candidate to seriously consider the job position. Such incentives can include perks of going through the interview process and being an employee at the company. For example, a perk can be receiving a monetary reward, or a physical gift (e.g., an iPad®) if the candidate applies and actually goes through the interview process for the job.

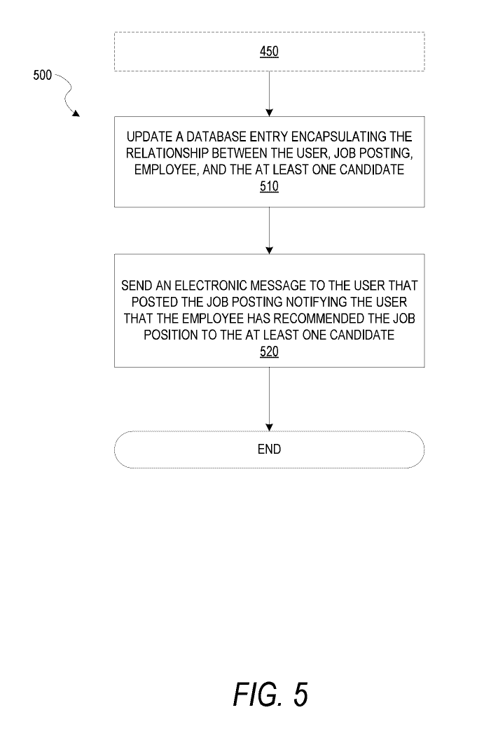

In various example embodiments, FIG. 5 is a flow diagram illustrating an example method 500 for sending and updating information in response to an employee electing to send a recommendation, according to example embodiments. At operation 510, in response to the employee electing to send a recommendation, the data module 230 updates a database entry encapsulating the relationship between the user, job posting, employee, and the at least one candidate. The database entry specifies the relationship between the three parties involved in the recruiting process including: the recruiter posting the job, the employee who recommended the job to his network, and the eligible candidate who received the recommendation. Each time an employee elects to send a recommendation as suggested by the recommendation prompt, the data module 230 updates the database to reflect the relationship. The information is used for later recommendation prompts to target employees who have sent recommendations in the past to people within their network.

At operation 520, in response to the employee 350 electing to send the recommendation, the recommendation module 220 sends an electronic message to the user that posted the job posting notifying the user that the employee has recommended the job position to the at least one candidate. The electronic message can be a separate email to the recruiter who posted the job posting 310 notifying the recruiter that the employee 350 has chosen to recommend this job to the candidate.

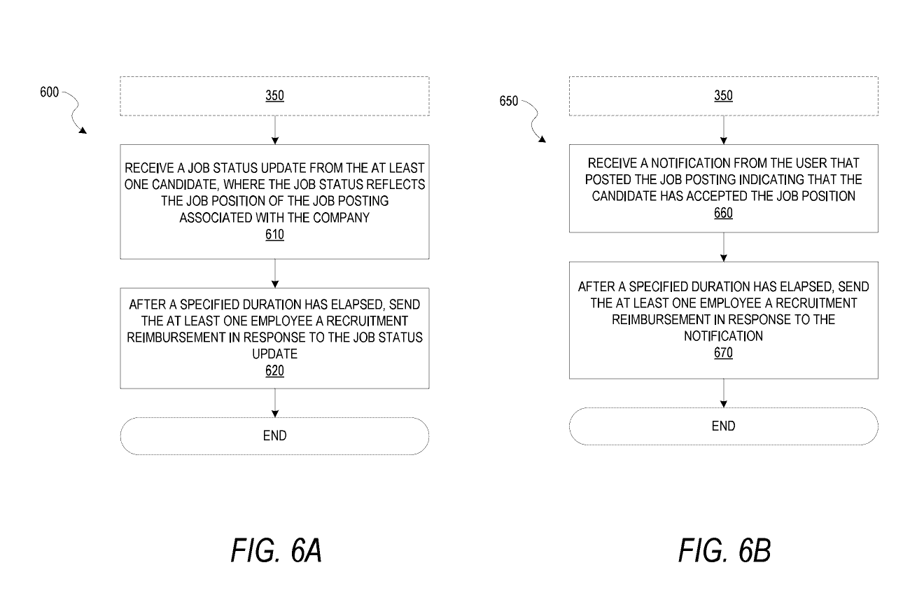

In various example embodiments, FIGS. 6A-6B are flow diagrams illustrating example methods 600 and 650 for determining a successful recruiting process of a candidate and distributing the recruitment reimbursement in response to the successful recruiting, according to example embodiments.

In various embodiments, when the eligible candidate and the recruiter receives the electronic message specifying the employee has recommended the job to the candidate, the recruiter can contact the candidate directly to further facilitate the interview process. At operation 610, the data module 230 receives a job status update from the at least one candidate, where the job status reflects the job position of the job posting associated with the company. The analysis module 240 of the recruiting system 200 can determine that the candidate was offered the job position and has accepted (e.g., a successful recruitment) when the candidate updates the job field in his member profile. The analysis module 240 can determine that the title in the job field entry and company matches the title of the job posting position. After the candidate accepts the job offer, the employee who recommended the job position to the candidate may be eligible for the recruitment reimbursement amount after a period of time has passed. The period of time is predetermined by the recruitment reimbursement terms associated with the job posting. At operation 620, after a specified duration has elapsed, the analysis module 240 sends the at least one employee a recruitment reimbursement (in the amount specified by the job posting or recruiter) in response a determined successful recruitment based on the status update of the candidate.

Moreover, the recruiting system 200 can determine that the recruiting process was successful based on a notification from the recruiter. Throughout the whole process, when the candidate applies to the job, the recruiter can notify the recruiting system 200 indicating that the candidate has applied to the job position via the employee. The data module 230 updates the database to reflect the application status of the candidate. If the candidate successfully finishes the interview process, is offered the job position, and accepts the position, the recruiter can notify the recruiting system 200 indicating that the candidate has accepted the job. At operation 660, the data module 230 receives a notification from the user that the posted the job posting indicating that the candidate has accepted the job position. The data module 230 updates the database to reflect the change in job status of the candidate. At operation 670, after a specified duration has elapsed (specified by the recruitment reimbursement associated with the job posting), the analysis module 240 sends the at least one employee a recruitment reimbursement (in the amount specified by the job posting or recruiter) in response to the notification from the recruiter.

FIG. 7 depicts an example user interface 700 for interactively presenting the recommendation prompt to the employee. Continuing with the example from FIG. 3, the analysis module 240 determined that the candidate 380 is an eligible candidate for the job posting, and sends a recommendation prompt the employee in the form of the employee's log-in home page. When the employee 350 logs in to the home page, the presentation module 220 presents a job description 710 of the job posting. The job description 710 includes the required and preferred qualifications of the job position that is open in the current company the employee 350 works for. The employee 350 can further look at the full description of the job by selecting selector 720 for further details such as recruitment reimbursement amounts for successfully recruiting a candidate. The recommendation prompt can further include a list of eligible candidates 730 in the employee's network. For each eligible candidate in the list 730, the recommendation prompt provides a suggestion 740 to recommend the specific open job position 710 to the eligible candidate. The employee 350 can choose to send the recommendation to the eligible candidate by selecting selector 750. In response to the employee selecting selector 750, the recommendation prompt causes presentation of an automated electronic message 750 to send to the candidate along with the option for the employee 350 to add a personalized message 770 to send along with the automated electronic message. Further, the recommendation prompt can provide a suggestion 780 to the employee 350 to send the specific open job position 710 to other people in the employee's network.

### Modules, Components, and Logic

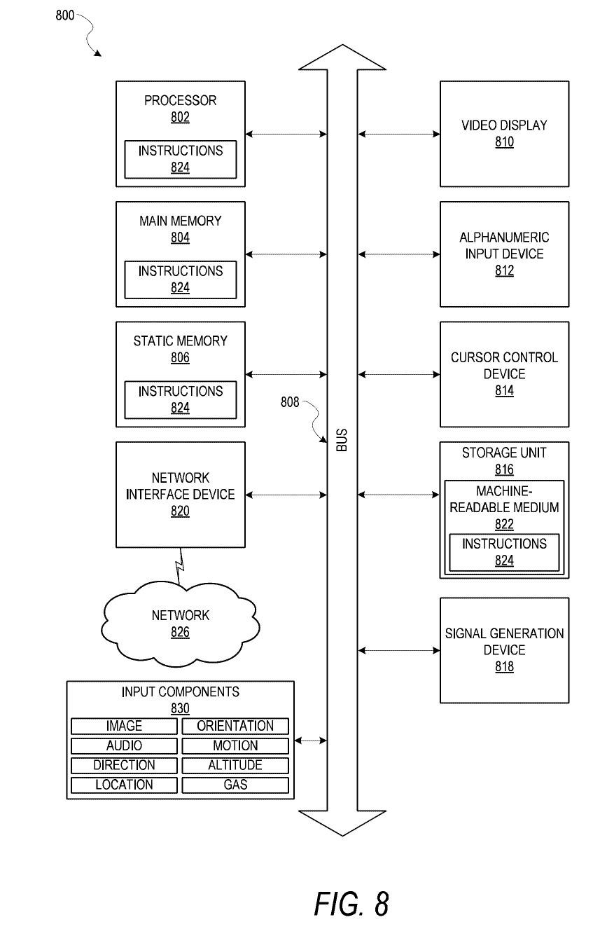

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 824 (e.g., software, a program, an application, an applet, an app, or other executable code) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include a collection of machines 800 that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the static memory 806, within the processor 802 (e.g., within the processor's cache memory), or all three, during execution thereof by the machine 800. Accordingly, the main memory 804, static memory 806 and the processor 802 may be considered as machine-readable media 822. The instructions 824 may be transmitted or received over a network 826 via the network interface device 820.

In some example embodiments, the machine 800 may be a portable computing device, such as a smart phone or tablet computer, and have one or more additional input components 830 (e.g., sensors or gauges). Examples of such input components 830 include an image input component (e.g., one or more cameras, an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing instructions (e.g., instruction 824) for execution by a machine (e.g., machine 800), such that the instructions, when executed by one or more processors of the machine 800 (e.g., processor 802), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. The term “machine-readable medium” specifically excludes non-statutory signals per se.

Furthermore, the machine-readable medium 822 is non-transitory in that it does not embody a propagating signal. However, labeling the machine-readable medium 822 as “non-transitory” should not be construed to mean that the medium is incapable of movement; the medium should be considered as being transportable from one physical location to another. Additionally, since the machine-readable medium 822 is tangible, the medium may be considered to be a machine-readable device.

The instructions 824 may further be transmitted or received over a communications network 826 using a transmission medium via the network interface device 820 and utilizing any one of a number of well-known transfer protocols (e.g., hypertext transfer protocol (HTTP)). Examples of communication networks include a local area network (LAN), a wide area network (WAN), the Internet, mobile telephone networks (e.g. 3GPP, 4G LTE, 3GPP2, GSM, UMTS/HSPA, WiMAX, and others defined by various standard setting organizations), plain old telephone service (POTS) networks, and wireless data networks (e.g., WiFi and BlueTooth networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 822 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, with a processor 802 being an example of hardware. For example, at least some of the operations of a method may be performed by one or more processors 802 or processor-implemented modules. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via the network 826 (e.g., the Internet) and via one or more appropriate interfaces (e.g., an application program interface (API)).

The performance of certain of the operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a processor, and a memory including instructions, which when executed by the processor, cause the processor to:
receive a job posting specifying a plurality of criteria for a job position from a user of a social network service;
determine the job posting is associated with a company comprising of at least one employee;
identify at least one candidate within the at least one employee's first-degree professional network by performing a credential match between the criteria of the job posting and credentials from each candidate member profile within the at least one employee's first-degree professional network the at least one employee being within a first-degree network of the company associated with the job posting;
calculate a score for each of the at least one identified candidate based on the credential match between the criteria of the job posting and credentials from the at least one identified candidate member profile;
assign the score to each of the at least one identified candidate; and
cause presentation of a recommendation prompt to the at least one employee within the first-degree professional network of the at least one identified candidate associated with the score that transgresses a predefined threshold, the recommendation prompt providing a suggestion to the employee to recommend the job position to the at least one candidate within the employee's first-degree professional network.

2. The system of claim 1, further comprising:
send an electronic message to the at least one candidate in response to the at least one employee electing to send a job recommendation for the job position to the at least one candidate; and
in response to the at least one employee electing to send the job recommendation, update a database entry to include a relationship network between the user, job posting, employee, and the at least one candidate.

3. The system of claim 1, further comprising:
receive a job status update from the at least one candidate;
determine a recruiting process is successful based on the received job status update reflecting the job position of the job posting associated with the company; and
after a specified duration has elapsed, send the at least one employee a recruitment reimbursement in response to the recruiting process determined to be successful.

4. A method comprising:
using one or more computer processors:
receiving a job posting specifying a plurality of criteria for a job position from a user of a social network service;
determining the job posting is associated with a company comprising of at least one employee;
identifying at least one candidate within the at least one employee's first-degree professional network by performing a credential match between the criteria of the job posting and credentials from each candidate member profile within the at least one employee's first-degree professional network, the at least one employee being within a first-degree network of the company associated with the job posting;
calculating a score for each of the at least one identified candidate based on the credential match between the criteria of the job posting and credentials from the at least one identified candidate member profile;
assigning the score to each of the at least one identified candidate; and
causing presentation of a recommendation prompt to the at least one employee within the first-degree professional network of the at least one identified candidate associated with the score that transgresses a predefined threshold, the recommendation prompt providing a suggestion to the employee to recommend the job position to the candidate within the employee's first-degree professional network.

5. The method of claim 4, further comprising:
sending an electronic message to the at least one candidate in response to the at least one employee electing to send a job recommendation for the job position to the at least one candidate.

6. The method of claim 4, further comprising:
receiving a job status update from the at least one candidate; and
determine a recruiting process is successful based on the received job status update reflecting the job position of the job posting associated with the company.

7. The method of claim 6, further comprising:
after a specified duration has elapsed, sending the at least one employee a recruitment reimbursement in response to the recruiting process determined to be successful.

8. The method of claim 4, further comprising:
receiving a notification from the user that posted the job posting indicating that the candidate has accepted the job position;
determine a recruiting process is successful based on the received notification from the user.

9. The method of claim 8, further comprising:
after a specified duration has elapsed, sending the at least one employee a recruitment reimbursement in response to the notification.

10. The method of claim 4, wherein the electronic message includes an incentive for the at least one candidate to apply for the job position and wherein calculating the score further comprise determining an average duration that each of the at least one identified candidates holds a job position using candidate member profile information.

11. The method of claim 4, further comprising:
in response to the at least one employee electing to send the job recommendation, sending an electronic message to the user that posted the job posting notifying the user that the employee has recommended the job position to the at least one candidate.

12. The method of claim 4, further comprising:
in response to the at least one employee electing to send the job recommendation, updating a database entry to include a relationship network between the user, job posting, employee, and the at least one candidate.

13. A machine-readable medium not having any transitory signals and storing instructions that, when executed by at least one processor of a machine, cause the machine to perform operations comprising:
receiving a job posting specifying a plurality of criteria for a job position from a user of a social network service;
determining the job posting is associated with a company comprising of at least one employee;
identifying at least one candidate within the at least one employee's first-degree professional network by performing a credential match between the criteria of the job posting and credentials from each candidate member profile within the at least one employee's first-degree professional network, the at least one employee being within a first-degree network of the company associated with the job posting;
calculating a score for each of the at least one identified candidate based on the credential match between the criteria of the job posting and credentials from the at least one identified candidate member profile;
assigning the score to each of the at least one identified candidate; and
causing presentation of a recommendation prompt to the at least one employee within the first-degree professional network of the at least one identified candidate associated with the score that transgresses a predefined threshold, the recommendation prompt providing a suggestion to the employee to recommend the job position to the candidate within the employee's first-degree professional network.

14. The machine-readable medium of claim 13, wherein the operations further comprise:
sending an electronic message to the at least one candidate in response to the at least one employee electing to send a job recommendation for the job position to the at least one candidate; and
in response to the at least one employee electing to send the job recommendation, updating a database entry to include a relationship network between the user, job posting, employee, and the at least one candidate.

15. The machine-readable medium of claim 14, wherein the operations further comprise:
receiving a job status update from the at least one candidate; and
determine a recruiting process is successful based on the received job status update reflecting the job position of the job posting associated with the company.

16. The machine-readable medium of claim 15, wherein the operations further comprise:
after a specified duration has elapsed, sending the at least one employee a recruitment reimbursement in response to the recruiting process determined to be successful.

17. The machine-readable medium of claim 13, wherein the operations further comprise:
receiving a notification from the user that posted the job posting indicating that the candidate has accepted the job position; and
determine a recruiting process is successful based on the received notification from the user.

18. The machine-readable medium of claim 17, wherein the operations further comprise:
after a specified duration has elapsed, sending the at least one employee a recruitment reimbursement in response to the notification.

19. The machine-readable medium of claim 14, wherein the electronic message includes an incentive for the at least one candidate to apply for the job position and wherein calculating the score further comprise determining an average duration that each of the at least one identified candidates holds a job position using candidate member profile information.

20. The machine-readable medium of claim 14, wherein the operations further comprise:
in response to the at least one employee electing to send the job recommendation, sending an electronic message to the user that posted the job posting notifying the user that the employee has recommended the job position to the at least one candidate.
